(19) United States
(12) Patent Application Publication
(10) Pub. No.: US 2026/0030644 A1
(43) Pub. Date: Jan. 29, 2026

(54) NETWORK ASSESSMENT ACROSS DIVERSE MANAGEMENT SERVICES

(71) Applicant: Ivanti, Inc., South Jordan, UT (US)

(72) Inventor: Robin Rowe, Daresbury (GB)

(73) Assignee: Ivanti, Inc., (US)

(21) Appl. No.: 19/279,980

(22) Filed: Jul. 24, 2025

Related U.S. Application Data
(60) Provisional application No. 63/675,034, filed on Jul. 24, 2024.

(51) Int. Cl. G06Q 30/0201

(52) U.S. Cl. CPC G06Q 30/0201

(57) ABSTRACT

A method of managed network service assessment across a plurality of diverse management services implemented in the managed network. The method includes receiving information associated with the managed network, including identification of endpoints, product status, use behaviour, and incident resolution data. The method further includes receiving implementation data representing the execution of management services in the managed network, categorizing the received information, and generating metrics related to the management services based on the received data and information. The metrics are standardized relative to the managed network to generate standard metrics indicating the maturity and adoption of the management services in the managed network. The standard metrics are grouped and combined according to service class. Combined class metrics are generated and displayed in a user interface.

### CROSS-REFERENCE TO RELATED APPLICATION

This application claims priority to and the benefit of U.S. Provisional Application No. 63/675,034, filed Jul. 24, 2024, which is incorporated herein by reference in its entirety.

### FIELD

The embodiments described in this disclosure are related to assessment of managed network of computing devices. In particular, some embodiments are directed to network assessment across multiple, diverse management services implemented in the managed network based on diverse metric quantification.

### BACKGROUND

In managed networks, multiple management services may be implemented. For instance, a managed network might implement an update management service, an application management service, and an information technology service management (ITSM) service. Oftentimes, a single service vendor may be providing the multiple management services simultaneously and over a long period of times such as one or more years.

Often, in these managed networks, metrics related to the management services are not quantified. In part, the lack of metrics is based on the difficulty in measuring the operation of different management services. For instance, the multiple management services may interact with the managed network in different ways. The metrics may accordingly be based on different values and parameters. In these managed networks, administrators are left without meaningful measures of maturity or adoption of the management services. In some conventional managed networks, instead of metrics related to the management services, one or more individualized reports might be generated such as a return-on-investment (ROI) calculation, a calculation of hours saved, etc. However, the reports are limited and usually relate to a single aspect of a single management service. Moreover, these reports fail to provide any insight regarding improvements to the implementation of the management services in the managed network. Overall use and maturity of management services across differing types is not determined, abstracted, or made available. Accordingly, there is a need in the field of management services for metric quantification in managed networks implementing multiple management services.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of network service assessment across multiple, diverse management services implemented in the managed network. For example, the management services may include a product update management service, an environment management service, an application control service, an external attack service management service, a preventative maintenance service, a self-healing service, a mobile device management service, a performance management service, a workspace integration service, a user outreach service, an automated information technology (IT) service management service, other management services, or combinations thereof. The method may include receiving network information associated with the managed network. The network information may include parameters of the managed network such as identification of at least a portion of endpoints of the managed network, product status at the endpoints, use behaviour at the endpoints, incident resolution data, other network information, or combinations thereof. The method may include receiving implementation data that represents execution of management services of the two or more diverse management services in the managed network. The method may include categorizing the received information into portions that are associated with one or more of the management services. The method may include generating service metrics related to the management services based on the implementation data and one or more portions of the received information. The service metrics may be configured to represent operation of one of the management services in the managed network. The method may include standardizing the service metrics relative to generated standard metrics. The standard metrics may indicate maturity and adoption of the management services in the managed network in an abstracted or normalized form. The method may include grouping the standard metrics according to two or more service classes. The service classes may be illustrative of timing and administrative involvement of the management services. The method may include combining the standard metrics with one or more other standard metrics of the same service class to generate a combined class metric for each of the service classes. The method may include generating graphical representation data of the combined class metrics. The method may include causing display of the graphical representation data of the combined class metrics in a unified user interface.

A first subset of the service classes may include a preventative services that operate to pre-emptively mitigate issues in the managed network. A second subset of the service classes are curative services that operate responsive to a condition or an event experienced in the managed network. The received network information may include information related to a policy implemented in the managed network and the received information may further be categorized into one or more additional portions that are associated with the policy. The method may further include generating an indirect metric related to the policy. The indirect metric may be indicative of maturity and adoption of the policy in the managed network. The indirect metric may be based on the additional portions of the received information and a part of the implementation data or derivatives of the part of the implementation data. The method may also include receiving historical data representing the operation of a portion of the managed network related to one or more of the management services during a particular period of time. The method may include generating a historical parameter based on the historical data and standardizing the historical parameter to generate a historical standard parameter. The method may include comparing the historical standard parameter to one or more of the standard metrics. The method may further include receiving an industry standard related to one or more of the management services. The method may include comparing the industry standard to one or more of the standard metrics and causing the display of a comparison between the industry standard and the one or more of the standard metrics. The method may also include generating one or more potential parameters. The potential parameters may represent at least one instance in which one or more of the management services are applicable in the managed network and not currently implemented. The potential parameters may be based on a portion of the received information and a first part of the implementation data. The method may include generating a recommendation. The recommendation may be based on one or more of the potential parameters and causing display of the recommendation. The recommendation may include changes to improve the operation of one or more of the management services.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIGS. 2A and 2B are block diagrams of an example managed network service assessment process that may be implemented in the operating environment of FIG. 1;

FIG. 3 is an example unified user interface that may be implemented in the managed network service assessment process of FIGS. 2A and 2B;

FIG. 4 illustrates an example computer system configured for managed network service assessment;

FIG. 5 is a flow chart of an example method of managed network service assessment;

FIG. 6 is a flow chart of an example method of metric generation that may be implemented in the method of FIG. 5;

FIGS. 7A and 7B are a flow chart of an example method of metric quantification supplementation,

all according to at least one embodiment described in the present disclosure.

### DESCRIPTION OF SOME EXAMPLE EMBODIMENTS

The embodiments described in this disclosure are related to managed networks. In particular, some embodiments are directed to metric quantification in managed networks implementing multiple, diverse management services.

In conventional managed networks, metrics related to the management services are not quantified. In part, the failure to quantify the metrics is based on diversity of the multiple management services and different values and parameters that contribute to the metrics. In these conventional managed networks, administrators lack meaningful measures and insights related to maturity and adoption of the management services.

Accordingly, some embodiments of the present invention are directed to systems and methods of metric quantification in a managed network implementing multiple, diverse management services. The metrics generated in the present disclosure may include service metrics that are related to one or more management services implemented in the managed network and indirect metrics that are related to a policy or an initiative implemented in the managed network. The metrics may be based on network information that is indicative of one or more characteristics of the managed network and implementation data that is representative of execution of the management services in the managed network. The service metrics are generated and standardized relative to the managed network. Standardized metrics represent the service metrics as applied to the managed network and abstracted relative to the other management services. The standardized metrics may represent maturity and adoption of the management services. The standard metrics may be grouped according to two or more service classes. The service classes are a set of the management services that all address management of the managed network in a particular way. For instance, the service classes are illustrative of timing of implementation of the management service and administrative involvement of the management services. The standard metrics of each of the service classes may be combined to generate a combined class metric for each of the service classes. The indirect metrics are based on portions of the network information and one or more parts of the implementation data or derivatives of the implementation data. The indirect metrics are indicative of the maturity and adoption of the policy or initiative implemented in the managed network. Graphical representation data of the combined class metrics and the indirect metrics may be generated and caused to be displayed in a unified user interface.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

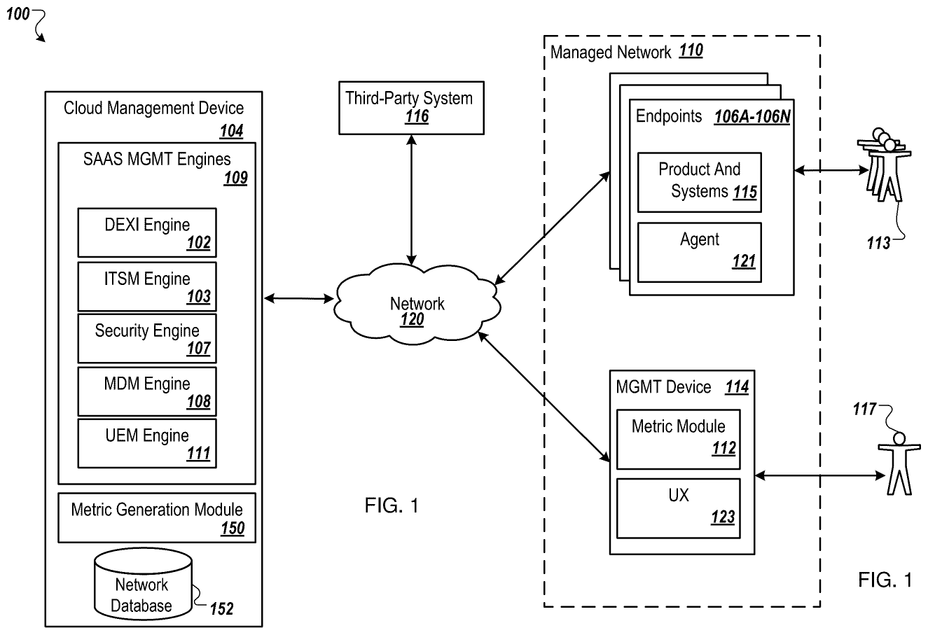

FIG. 1 depicts an example operating environment 100 in which some embodiments may be implemented. The operating environment 100 may include a cloud management device 104 communicatively coupled to one or more endpoints 106A-106N (generally, endpoints 106) organized into a managed network 110. The cloud management device 104 is configured to provide a plurality of diverse, management services to the managed network 110. For instance, the cloud management device 104 may provide a product update management service, an environment management service, an application control service, an external attack service management service, a preventative maintenance service, a self-healing service, a mobile device management service, a performance management service, a workspace integration service, a user outreach service, an automated information technology service management (ITSM) service, another management service, or combinations thereof.

In the operating environment 100, because the diversity between the management services, it is difficult to quantify metrics that reflect adoption and maturity of the management services. For instance, factors indicative of adoption and maturity of a user outreach service are different from factors indicative of utilization and maturity of the automated ITSM service. Additionally, it is difficult to quantify metrics that reflect adoption and maturing of policies and initiatives implemented in the managed network 110. Accordingly, in the operating environment 100, the cloud management devices 104 includes a metric generation module 150 that is configured to quantify metrics across the management services and abstract the metrics to enable a broad assessment of the management services relative to one another. Additionally, the metric generation module 150 is configured to quantify metrics related to the policies and initiatives implemented in the managed network 110. Moreover, the metric generation module 150 generates potential parameters that may improve utilization of the management services in the managed network 110. For instance, the metrics generation module 150 is configured to pull network information associated with the endpoints 106 and to receive data representative of execution of one or more of the management services. Based on the received data and the information, metrics are quantified for the one or more management services, which are referred to as service metrics. The metrics generation module 150 may standardize the service metrics. Standardized metrics are grouped and combined according to service classes.

In addition, in some embodiments, the metrics generation module 150 may generate indirect metrics. The indirect metrics may be derived from the received data, the network information, service metrics, or some combination thereof. The indirect metrics may quantify maturity, adoption, satisfaction, or some combination of the initiatives and the policies affecting the managed network 110. For instance, an enterprise associated with the managed network 110 may implement a remote work initiative. The metrics generation module 150 may generate an indirect metric that reflects the adoption and satisfaction of the remote work policy.

The metric generation module 150 may be configured to generate graphical representation data of the combined standardized metrics and/or the indirect metrics. The graphical representation data may be displayed in a unified user interface. Additionally, the metrics generation module 150 assesses adoption and maturity of the management services in the managed network 110 and provides one or more recommendations to modify one or more of the management services in the managed network 110.

The metrics quantification may provide a technical advantage relative to conventional systems that do not implement the metrics generation systems and methods described in the present disclosure. For instance, in some conventional systems, a return on investment (ROI) calculation of a single management service may be provided. The ROI calculation is displayed independently instead of being abstracted relative to other managed services. The ROI calculation is often based on a simple calculation of a single parameter (e.g., number of incidents resolved). The ROI calculation has limited utility in its implementation to a managed network as a whole and relative to other management services implemented in the managed network. Accordingly, in conventional systems, overall adoption and maturity of management services across differing types is not determined, abstracted, or made available to a user.

Embodiments of the present disclosure provide a technical improvement to conventional management systems. Specifically, embodiments of the present disclosure use real-time implementation data along with network information related to the managed network 110 to quantify adoption and maturity of the management services as well as policies and initiatives implemented in the managed network 110. The service metrics are abstracted and standardized to enable comparison between the management services as applied in the managed network 110. Additionally, the service metrics may be grouped according to service class, which provides combined metrics related to timing and administrative involvement.

Accordingly, examples of the present disclosure are directed to a computer-centric problem and are implemented in a computer-centric environment. For instance, the examples of the present disclosure are directed to cloud-based management services of the managed network 110. Computing processes occurring in the operating environment 100 include communication and implementation of implementation data, standardization, and quantification the implementation data, and generation of an electronic unified user interface for visualization of graphical data. Communications during the processes described in this present disclosure involve the communication of data in electronic and optical forms via a network 120 and also involve the electrical and optical interpretation of the data and information.

In the embodiment of FIG. 1, the operating environment 100 may include the endpoints 106, the cloud management device 104, a local management device 114, and a third-party system 116 that communicate via the network 120. The network 120 is configured to communicate data and information between the endpoints 106, the local management device 114, the third-party system 116, and the cloud management device 104. These components of the operating environment 100 are introduced in the following paragraphs.

The network 120 may include any communication network configured for communication of signals between the components (e.g., 104, 114, 116, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some embodiments, the network 120 may include a peer-to-peer network. The network 120 may also be coupled to or include portions of a telecommunications network that may enable communication of data in a variety of different communication protocols.

In some embodiments, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The depicted example of the operating environment 100 includes the third-party system 116. The third-party system 116 may include a hardware-based server configured to communicate data and information with the other components of the operating environment 100 via the network 120. The third-party system 116 may be configured to host and make accessible information and data related to industrial standards. For example, the metric generation module 150 may be configured to provide a comparison between adoption of one of the management services in the managed network 110 and adoption of the management service throughout an industry. In these embodiments, the cloud management device 104 may access information related to utilization in the industry from the third-party system 116. For example, the managed network 110 may be associated with a bank and one of the management services may include a product update management service implemented by a security engine 107. In the managed network 110, products and systems (hereinafter, “products”) 115 at the endpoints 106 may be patched according to a particular cadence (e.g., as every month). Throughout the banking industry, other networks may be patched at a higher cadence such as every twenty-eight (28) days. The cloud management device 104 may access information that reflects the patching cadence in the bank industry and the metric generation module 150 may generate a comparison between the implementation of the patch management service in the managed network 110 and the cadence of the bank industry.

The managed network 110 includes the local management device 114 and the endpoints 106. The managed network 110 is implemented to enable management of the endpoints 106 by the cloud management device 104. To implement the managed network 110, the endpoints 106 may be enrolled. After the endpoints 106 are enrolled, ongoing management of the endpoints 106 may be implemented by the cloud management device 104. The ongoing management may include overseeing and dictating at least a part of the operations at the endpoints 106 as well as dictate or control guidelines such as application guidelines, security guidelines, communication guidelines, etc. as described in the present disclosure. The managed network 110 may be associated with an enterprise, a portion of an enterprise, a government entity, or another entity or set of devices.

The endpoints 106 may include hardware-based computer systems that are configured to communicate with the other components of the operating environment 100 via the network 120. The endpoints 106 may include any computer device that may be managed by the cloud management device 104 and/or have been enrolled in the managed network 110. Generally, the endpoints 106 include devices that are operated by the personnel and systems of an enterprise or store and process data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines.

The endpoints 106 include the products 115 and an agent 121. The products 115 may include applications or subsystems of any kind or type. Some examples of the products 115 may include software applications, enterprise software, operating systems, and the like. The product 115 may not be the same in all endpoints. For instance, a first set of products 115 of a first endpoint 106A may include a first set of software applications while a second set of products 115 on a second endpoint 106B may include a second set of software applications, which may include at least one software application that is not included in the first set of software applications.

The agent 121 may be locally installed at least temporarily on the endpoints 106. For instance, the agent 121 may be installed on the endpoints 106 when the endpoints 106 are enrolled in the managed network 110 or when a particular management service is provided to the endpoints 106. The agent 121 may have access to information related to the products 115, user behavior and operation of the endpoint 106, etc. and may be configured to communicate the information such as product metadata related to the products 115, incident symptoms and mitigation, workstation components, etc. to the cloud management device 104. On its own or responsive to a request (from the cloud management device 104 or another endpoint 106), the agent 121 may communicate the information related to the endpoint 106. The agent 121 may also implement administrative and/or management processes within the managed network 110.

The endpoints 106 may be associated with one of the users 113. The phrase “associated with” when describing the relationship between the endpoints 106 and the users 113 indicates that the users 113 generally or regularly operate the endpoints 106. Because this association, references to communication of a message or inquiry to the user 113 may indicate that the inquiry is communicated to the endpoint 106 associated with the user 113. Similarly, a response by one of the users 113 may indicate that the user 113 provided user input to the endpoint 106, which is communicated to the cloud management device 104. As the user 113 operates the endpoint 106, user behavior data may be gathered (e.g., by the agent 121), which may be communicated to the cloud management device 104. Additionally, the user 113 may answer or respond to a survey using one of the endpoints 106, which may be communicated to the cloud management device 104.

The local management device 114 may include a hardware-based computer system that is configured to communicate with the other components of the operating environment 100 via the network 120. The local management device 114 is configured to assist in the provision of management service in the managed network 110. The local management device 114 may be associated with an administrator 117. The administrator 117 may be an individual, a set of individuals, or a system that interfaces with the local management device 114. In some examples, the administrator 117 may provide input to the local management device 114. The input provided by the administrator 117 may form the basis of some computing processes performed by the local management device 114 and the cloud management device 104.

Additionally, the local management device 114 may include a metric module 112 and a user interface (UX) 123. The metric module 112 may be configured to receive data and information from the cloud management device 104. For instance, the metric module 112 may be configured to receive potential parameters, standard metrics, combined class metrics, indirect metrics, recommendations, graphical representation data of the standard metrics and indirect metrics, graphical representation data of the combined class metrics, or some combination thereof from the metric generation module 150. The metric module 112 may interpret the data and present it in the UX 123. The administrator 117 may interact with the UX 123. For instance, the administrator 117 can visualize the combined class metrics, the standardized metrics, the indirect metrics, or some combination thereof. Additionally, the administrator 117 may review the potential parameters and recommendations for implementation in the managed network 110.

In some embodiments, the local management device 114 is one of the endpoints 106. For instance, the local management device 114 may include products 115 and/or the agent 121. Additionally, in some embodiments, the local management device 114 may be omitted, and the administrator 117 may use one of the endpoints 106 to interface with the cloud management device 104 remotely via the network 120.

The cloud management device 104 may include a hardware-based computer system that is configured to communicate with the other components of the operating environment 100 via the network 120. In some embodiments, the cloud management device 104 may be a single server, a set of servers, a virtual device, or a virtual server in a cloud-base network of servers. In these and other embodiments, one or more of the components of the cloud management device 104 (e.g., the metric generation module 150 and a software as a service (SAAS) management engines 109) may be spread over two or more cores, which may be virtualized across multiple physical machines.

As introduced elsewhere in the present disclosure, the cloud management device 104 operates to provide management services to the endpoints 106. The management services may include any service that administers, controls, establishes, or restricts operation of the managed network 110 or at least a portion of the endpoints 106. Some examples of the management services include a product update management service, an environment management service, an application control service, an external attack service management service, a preventative maintenance service, a self-healing service, a mobile device management service, a performance management service, a workspace integration service, a user outreach service, an automated ITSM service, another management service, or combinations thereof.

The management services may include one or more preventative services that operate to pre-emptively mitigate issues in the managed network 110. Additionally, the management services may include one or more curative services that operate responsive to a condition or an event experienced in the managed network 110. Additionally, the management services may be separated into one or more service classes. The service classes are based on the timing the management service is implemented and/or an involvement of the administrator 117 or the user 113. In some embodiments, the services classes include inoculation, preventative maintenance, proactive automation, self-heal, self-service, and analyst acceleration. The inoculation service class may include management services that create a condition or state in the managed network 110 that prevent an unstable or unsecure environment. The preventive maintenance service class may include actions taken relative to the endpoints 106 periodically to provide a relatively constant state or updates to the endpoints. The proactive automation may include some management service tasks that are performed without interaction by the user 113 or the administrator 117 responsive to some condition. The self-healing may include automated mitigations and changes to the managed network 110 without action by the users 113 or the administrator 117. The self-service may include one of the users 113 implementing a change to one of the endpoints 106. Some examples may include providing instructions or prompting one or more of the users 113 to implement the change. The analyst acceleration class may include active involvement of an IT analyst or personnel to change a configuration or mitigate a condition in the managed network 110.

To provide the management services, the cloud management devices 104 includes the SAAS management engines (in the Figures “SAAS MGMT engines”) 109 that are configured to perform one or more of the management services relative to the endpoints 106. For instance, the SAAS management engines 109 of FIG. 1 includes a digital experience index (DEXI) engine 102, an ITSM engine 103, a security engine 107, a mobile device management (MDM) engine 108, a unified endpoint management (UEM) engine 111. In other embodiments, the SAAS management engine 109 may include other engines or modules configured to implement other management services or some combination of those included in FIG. 1.

The DEXI engine 102, the ITSM engine 103, the security engine 107, the MDM engine 108, and the UEM engine 111 may provide one or more management services implemented in the operating environment 100. For instance, the DEXI engine 102 may receive attributes data from the managed network 110 and the SAAS management engine 109 and determine experience of the users 113. The attribute data might include implementation data related to the other SAAS management engines 109 as well as network information related to the endpoints 106. The ITSM engine 103 provides incident response, ticketing, and resolution services. The security engine 107 provides patch and update management for the products 115. The MDM engine 108 provides endpoint configuration such as communication policies, application management, security policies, etc. The UEM engine 111 may provide endpoint discovery, application management, etc.

During implementation of the management services, data is generated. The data represents execution of one of the management service in the managed network 110. For instance, each time the security engine 107 distributes a patch to the endpoints 106, there is data associated with the distribution. Similarly, each time an incident ticket is generated at one of the endpoints 106, which is addressed by the ITSM engine 103, there is data associated with it. This data is collectively referred to as “implementation data” throughout the present disclosure.

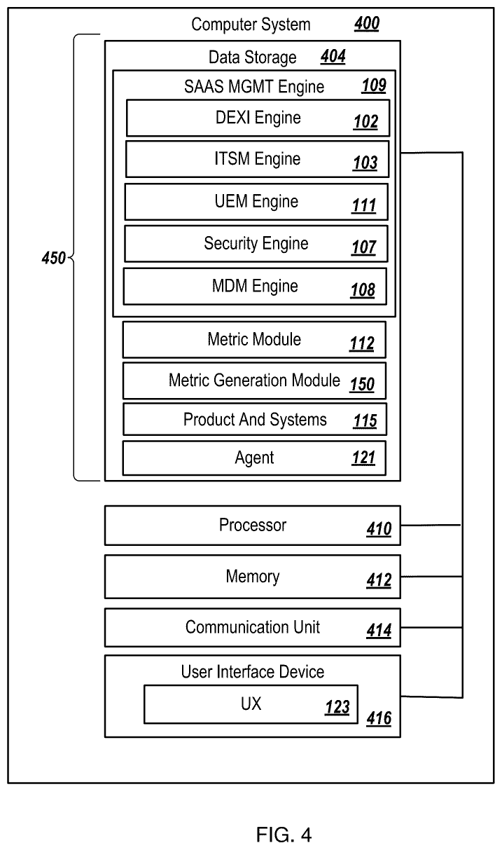

The cloud management device 104 includes a network database 152. The network database 152 includes non-transitory storage media such as the memory 412 of FIG. 4. In some embodiments, the network database 152 may store at least some of the implementation data. The implementation data may be stored based on a time at which it is generated.

The cloud management device 104 includes the metric generation module 150. The metric generation module 150 is configured to quantify metrics of the SAAS management engines 109 and metrics of policies and initiatives implemented in the managed network 110. For instance, the metric generation module 150 may be configured to receive information associated with the managed network 110, referred to herein as “network information.” The network information may include identification of at least a portion of endpoints 106, product status at the endpoints 106, use behavior at the endpoints 106, incident resolution data, policy and initiative information, other information related to the managed network 110, or combinations thereof. The metric generation module 150 may categorize the received information such that a first portion of the received information is associated with a first management service and a second portion of the received information is associated with the second management service. For instance, the first portion may be categorized with ITSM services, and the second portion may be categorized with UEM services. Additionally, the metric generation module 150 may categorize a portion of the network information as being associated with one or more of the policies and initiatives implemented in the managed network 110. The categorizing the received information is based on one or more features of the management service such that network information relevant to the management service forms the bases of the first and the second portions.

The metric generation module 150 may receive implementation data from one or more of the SAAS management engines 109 (e.g., such as the ITSM engine 103 and the UEM engine 111). Based on the implementation data and one or more portions of the received network information, the metric generation module 150 may generate one or more service metrics related to one or more of the management services. The service metrics are configured to represent the operation of the management service in the managed network 110. The metric generation module 150 may standardize the service metrics relative to the managed network 110 to generate standard metrics. The standard metrics indicate maturity and adoption of each of the management services. The metric generation module 150 may group the standard metrics according to the service classes and combine the standard metrics with one or more other standard metrics that are grouped into the same service class to generate a combined class metric for the service classes.

In addition, the metric generation module 150 may generate the indirect metrics. The indirect metrics may relate to adoption, maturity, satisfaction, or some combination of a policy or initiative implemented in the managed network 110. For instance, one or more parts of the implementation data or derivatives thereof may be associated with a policy. The implementation data along with a portion of the network information may indicate a number or percentage of the endpoints 106 that have adopted the policy and user satisfaction with the policy.

The metric generation module 150 may generate graphical representation data of the combined class metrics and/or the indirect metrics. The metric generation module 150 may then cause display of the graphical representation data in a unified user interface. For instance, the combined class metrics and the indirect metrics may be communicated to the metric module 112 to be displayed at the UX 123.

In addition, in some embodiments, the metric generation module 150 may generate potential parameters. The potential parameters represent at least one instance in which the one or more of the management services is applicable in the managed network 110 and not currently implemented. The potential parameters may be based on one or more portions of the received network information and the implementation data. The metric generation module 150 may generate a recommendation based on the potential parameters. The metric generation module 150 may cause display of the recommendation. For instance, the metric generation module 150 may communicate the recommendation to the metric module 112 for display on the UX 123. In addition, the metric generation module 150 may generate policy recommendations, which may indicate a modification to the policy or to the management services that may improve adoption or satisfaction with the policy or the initiative.

The SAAS management engine 109, the metric generation module 150, at least some of the products 115, the agent 121, the metric module 112, combinations thereof, and components thereof may be implemented using hardware including a processor, a microprocessor (e.g., to perform or control performance of one or more operations), a field-programmable gate array (FPGA), or an application-specific integrated circuit (ASIC). In some other instances, SAAS management engine 109, the metric generation module 150, at least some of the products 115, the agent 121, the metric module 112, combinations thereof, and components thereof may be implemented using a combination of hardware and software. Implementation in software may include rapid activation and deactivation of one or more transistors or transistor elements such as may be included in hardware of a computing system (e.g., the endpoints 106, the local management device 114, or the cloud management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more cloud management devices 104, one or more endpoints 106, one or more third-party systems 116, one or more local management devices 114, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

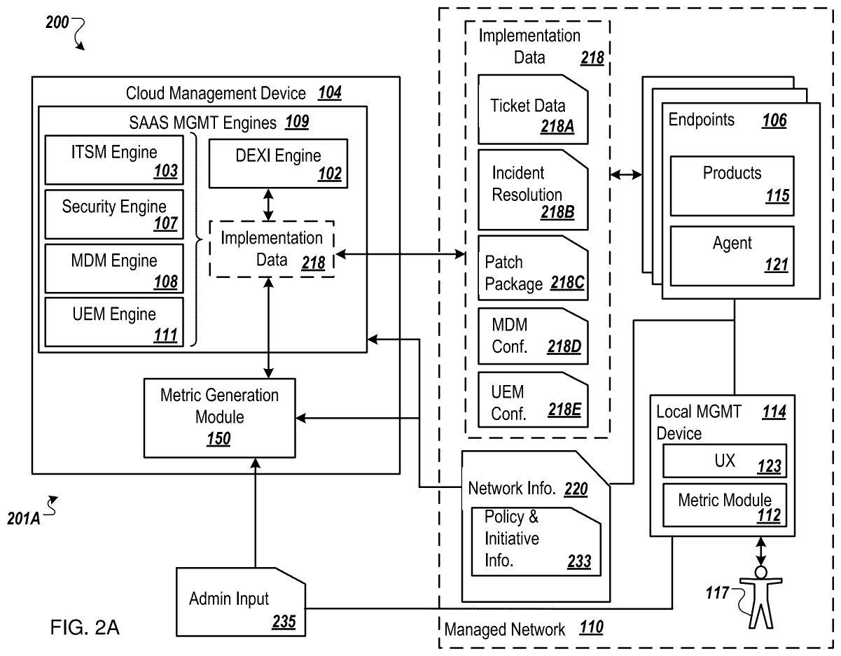

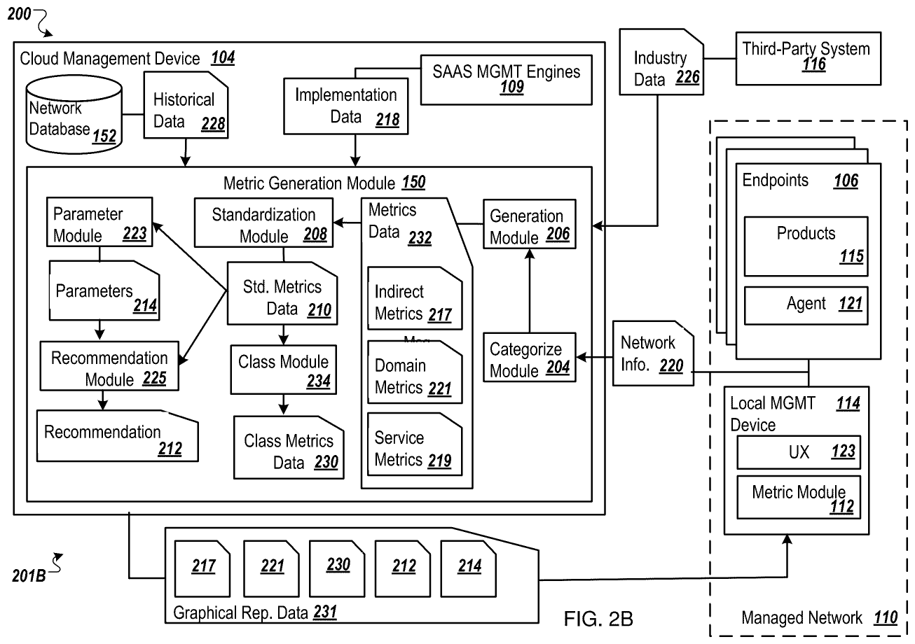

FIGS. 2A and 2B are block diagrams of an example managed network service assessment process (hereinafter, “process”) 200 that may be implemented in the operating environment 100 of FIG. 1 or another suitable environment. FIGS. 2A and 2B include one or more components (e.g., 116, 104, 102, 103, 108, 111, 150, 114, 123, 112, 121, 115, 106, etc.) described with reference to FIG. 1. Although not shown in FIGS. 2A and 2B, communication of data and information in the process 200 may be via a network such as the network 120 of FIG. 1.

In the embodiment of FIGS. 2A and 2B, the management services implemented in the managed network 110 are diverse and different from one another. Diversity of the management services creates difficulties in quantifying the metrics and abstracting the metrics relative to one another and the managed network 110. For instance, the measure of the maturity of a product update management service in the managed network 110 may be based on a percentage of the endpoints 106 that have unaddressed, critical vulnerabilities. In contrast, the measure of the maturity of an ITSM service may be based on a number of incidents that are automatically addressed without actions by IT personnel. In the process 200, the metric generation module 150 is configured to quantify and abstract metrics related to the management services implemented by the SAAS management engines 109. Additionally, in the process 200, the metric generation module 150 is configured to quantify indirect metrics related to policies and initiatives implemented in the managed network 110.

FIG. 2A depicts an example data collection stage 201A of the process 200. In the process 200, the metric generation module 150 may receive the network information 220 (in FIGS. 2A and 2B, “Network Info.”). The network information 220 may include identification of at least a portion of the endpoints 106 of the managed network 110, the products 115 at the endpoints 106, product status of the products 115 at the endpoints 106, user behavior at the endpoints 106, ticket or incident resolution data, device configuration information, other information related to the managed network 110, or combinations thereof. In addition, in some embodiments, the network information 220 may include policy and initiative information 233. The policy and initiative information 233 may include policy terms, initiative parameters, jurisdictions in which a policy is implemented, a subset of the endpoints 106 to which a policy applies, and the like.

In some embodiments, the network information 220 may be obtained during an endpoint discovery operation, endpoint check-in operations, endpoint enrolment operations, etc. Additionally, the local management device 114 may communicate or enable access to at least a portion of the network information 220 such as device configurations, network configuration, security guidelines, roles of users, user identifiers, policies and initiative, and the like. Additionally or alternatively, the network information 220 may be communicated by the agent 121 periodically or in real time. For instance, the agent 121 may be used in a product update management service. During product update management service operations (e.g., patch deployment or patch intelligence data acquisition), the agent 121 may communicate product status information. The network information 220 may be communicated to the metric generation module 150 and to the SAAS management engines 109. The network information 220 may be used in the performance of the management services.

Based on the network information 220, the metric generation module 150 may have data representative of characteristics and parameters of the managed network 110. For instance, the metric generation module 150 may know a number of the endpoints 106, the products 115, policies and preferences implemented in the managed network 110, users (e.g., 113), user roles, initiatives and policies implemented in the managed network 110, etc. The network information 220 may be used to generate the standard metrics data 210 and indirect metrics 217 as described elsewhere in the present disclosure.

The metric generation module 150 may also receive implementation data 218. The implementation data 218 represents execution of one or more of the management services in the managed network 110. For instance, as one or more of the SAAS management engines 109 perform tasks, the implementation data 218 is generated and communicated to the metric generation module 150.

One or more or each of the SAAS management engines 109 may communicate parts of the implementation data 218 to the metric generation module 150. For instance, the ITSM engine 103 may communicate a first part of the implementation data 218 to the metric generation module 150. The first part may be related to ITSM management services such as ticket data 218A, incident resolution data 218B, and the like. Similarly, the security engine 107 may communicate a second part of the implementation data 218 to the metric generation module 150. For instance, the security engine 107 may communicate patch package data 218C distributed to the endpoints 106, outstanding update information, unpatched endpoint data, etc. to the metric generation module 150. Accordingly, the metric generation module 150 has access to the implementation data 218 that indicates the execution of the management services in the managed network 110. In some embodiments, each of the SAAS management engines 109 (e.g., the DEXI engine 102, the ITSM engine 103, the security engine 107, the MDM engine 108, the UEM engine 111) may communicate parts of the implementation data 218. The part communicated by each of the SAAS management engines 109 is related to the management service it performs.

Additionally, in some embodiments, one or more parts of the implementation data 218 may be communicated from the endpoints 106. For instance, the ticket data 218A may be generated at one of the endpoints 106 using an ITSM interface. The ticket data 218A may be communicated to the ITSM engine 103 for resolution along with the metric generation module 150.

Some examples of the implementation data 218 may include the ticket data 218A, the incident resolution data 218B, the patch package data 218C, MDM configuration data 218D, UEM configuration data 218E, other data indicating or representing implementation of management services at the managed network 110, or combinations thereof. The management services implemented by the SAAS management engines 109 are different. Accordingly, a first part of the implementation data 218 (e.g., 218C) and a second part of the implementation data 218 (e.g., 218A) may be different. Indeed in some embodiments, the first and the second parts of the implementation data 218 may include entirely different data.

In some embodiments, the metric generation module 150 may include admin input 235. The admin input 235 may include the network information 220 in some circumstances. The admin input 235 may also include domain selection input. The domain selection input may define or identify a domain within which one or more of the metrics are directed. For instance, the admin input 235 may include an identification of a human resources (HR) domain. Accordingly, one or more of the metrics output by the metrics generation module 150 may be directed to management service maturity and adoption within the identified domain. Additionally, in some embodiments, the admin input 235 may include a selection of the policy or the initiative. Responsive to the admin input 235, the metric generation module 150 may generate a policy metric related to the selected policy or the selected initiative.

FIG. 2B depicts an example quantification stage 201B of the process 200. The quantification stage 201B may be implemented following the data collection stage 201A of FIG. 2A in some embodiments. The quantification stage 201B of the process 200 is implemented to generate metrics and supplementary information based on the implementation data 218, the network information 220, and the admin input 235. The metrics represent the adoption and maturity of the management services and policies in the managed network 110. The metrics enable analysis of the management services and the policies. For instance, the metrics or derivatives thereof may reflect implementation of each of the management services relative to the others, implementation of one or more of the management services in a particular domain, and implementation of a policy or initiative in the managed network 110.

The quantification stage 201B of the process 200 may begin with the metrics generation module 150 receiving the network information 220. The metric generation module 150 may include a categorization module 204. The categorization module 204 may be configured to categorize the received network information 220. For example, the received network information 220 may be categorized such that portions of the received network information 220 are associated with one or more of the management services and such that portions of the received network information 220 are associated with one or more initiatives or policies implemented in the managed network 110.

In some embodiments, the categorizing the received network information 220 is based on features of a related management service. For instance, the network information 220 may include a number of the endpoints 106. The number of endpoints 106 may be relevant to the product update management service, a UEM service, and a remote work policy implemented in the managed network 110. Accordingly, the number of endpoints 106 may be categorized as being relevant to the product update management service, the UEM service, and for a remote work policy. The network information 220 may also include update distribution to the products 115. The update distribution to the products 115 may only be related to the patch management service and not the UEM service or the remote work policy. Accordingly, the update distribution to the products 115 may be categorized as being relevant to the patch management service. Thus, categorized network information may include multiple portions that are associated with one or more management services and policies as well as other portions that are associated with other management services and/or other policies. Additionally, in some embodiments, the categorization may be domain specific. For instance, portions of the network information 220 that are related to human resources processes may be categorized together as being associated with the HR domain.

The metric generation module 150 may include a generation module 206. The generation module 206 may generate metrics data 232. The metrics data 232 may be generated for one or more or each of the management services, for one or more or each of the management services as implemented in a particular domain, for one or more of the initiatives or policies implemented in the managed network 110, or some combination thereof. The metrics generated for the management services are referred to as service metrics 219. The metrics generated for the management services and limited or directed to a domain are referred to as domain metrics 221. The metrics generated for a policy or an initiative are referred to as indirect metrics 217.

The indirect metrics 217 indicate the adoption, maturity, and potentially the satisfaction of a policy or an initiative implemented in the managed network 110. The indirect metrics 217 may not relate directly to implementation of one or more of the management services and may be derived from the implementation data 218 and network information 220. The service metrics 219 indicate the adoption and maturing of one or more management services in the managed network 110. The domain metrics 221 indicate adoption and maturity of one or more management services in a particular domain. The domain metrics 221 may be derived from or represent a portion of one or more of the service metrics 219.

The metrics data 232 are based on parts of the implementation data 218 communicated by the SAAS management engines 109 and one or more portions of the received network information 220 categorized with each of the management services, a particular domain, or associated with the initiatives or policies implemented int the managed network 110. For instance, a first service metric of the metrics data 232 may be generated that is related to a first management service (e.g., the ITSM service). The first service metric may be generated based on a first part of the implementation data 218 communicated by the first management service and the first portion of the received network information 220 associated with the first management service by the categorization module 204. The first service metric may be configured to represent operation of the first management service in the managed network 110. Similarly, a first indirect metric (e.g., 217) may be based on a second or a third part of the implementation data 218 or derivatives thereof communicated by the first and the second management services and a second portion of the received network information 220.

The service metrics 219 differ based on the management service it describes. For example, the management service may include a product update management service. The service metric 219 related to the product update management service may include a number of the endpoints 106 patched according to a guideline compared to a number of discovered endpoints 106, an implemented patching cadence, a time to patch across the managed network 110, a patch compliance rate, a patch installation success rate, a number of failed patch remediations, or an analysis of received patch feedback. The service metrics 219 related to the product update management service may be aggregated or apportioned to indicate maturity and adoption of a sub-function such as product updates related to Linux™ systems or related to Google™ products.

The management service may also include a knowledge management service. The service metric 219 related to the knowledge management service may include a number of incident deflections or a number of escalations. The management service may also include an automated ITSM service. The service metric 219 related to the automated ITSM service may include a number of automated ticket resolutions or MTTR. The management service may also include a user outreach service. The service metric 219 related to the user outreach service may include examples of or a number of sentiment surveys communicated to the endpoints 106, a percentage of users (e.g., 113) who are surveyed, a number of digital experience sentiment facets measured, a net promotor score, a user response rate, a number of actions launched from surveys, trends of user sentiment, or a number of generative AI topics explored. In addition, the domain metric 221 related to the user outreach service may include aggregated response analysis of the sentiment surveys. Accordingly, the domain metric 221 may indicate issues that employees experience relative to a particular domain such as an office facility, user satisfaction with hybrid or remote work environments, and the like. The domain metric 221 may indicate maturity, adoption, and satisfaction of within the particular domain.

The management service may include a workspace integration service. The service metric 219 related to the workspace integration service may include a number of remote control sessions, a number or list of edge intelligence sensors used, a description of custom action bots launched that is based on a number of endpoints and a number of distinct actions used, a number of description of incidents that are capable of being accelerated. The management service may include a performance management service. The service metric 219 related to the performance management service may include a number of central processing unit (CPU) clamping events, a number of memory trims, or a number of resource exhaustion events. The management service may include an MDM service. The service metric 219 related to the MDM service may include a number of managed endpoints 106 compared to a total number of discovered devices, managed application usage, passwordless authentication usage, or policy configuration usage. The management service may include a self-healing service. The service metric 219 related to the self-healing service may include a number of self-heal operations performed, a number of tickets deflected, a number of tickets accelerated, or productivity hours returned. The management service may include a self-healing service a preventative maintenance service. The service metric 219 related to the preventative maintenance service may include a number of healing bot operations performed, a number of tickets prevented, or a number of productivity hours saved. The management service may include external attack service management (EASM) service. The service metric 219 related to the EASM service may include a feature usage metrics such as page views and insights regarding leverage. The management service may include an application control service. The service metric 219 related to the application control service may include a number of compliant devices compared to a number of discovered endpoints, local administrator login use, trends in administrative login, enabled trusted ownership checking, automated negotiating agent's competition usage, or browser restriction usage. The management service may include an environment management service. The service metric 219 related to the environment management service may include a group policy action usage that reduces potential for failures by locking down unused items and enforcing security, login time performance that include parallelising or deferring login actions with the environment management service to improve performance, desktop compositions usage, or a number of managed devices compared to a number of unmanaged devices.

The indirect metrics 217 generally relate to policies and initiatives implemented in the managed network 110 such as remote work policies, software or hardware transitions, employee or team formation, role assignments, product utilization, and the like. The indirect metrics 217 might reflect adoption and maturity of the policies in the managed network 110, which may be specifically generated based on subsets of the endpoints 106 (e.g., based on jurisdiction, teams, device type, etc.). Additionally, the indirect metrics 217 may indicate satisfaction of the policies, which may be based on surveys, service tickets, and the like. The indirect metrics 217 may be standardized across policies or across jurisdictions, etc. For instance, satisfaction of the remote work policy in Indian may be standardized to compare satisfaction of the remote work policy in Europe.

The metric generation module 150 may include a standardization module 208. The standardization module 208 may standardize the metrics data 232 or a portion thereof to generate the standard metrics data 210. For example, the metrics data 232 include the service metrics 219 that may be standardized relative to the managed network 110 and relative to one another. For instance, the standard metrics data 210 indicate maturity and adoption of the management services in the managed network 110. The standard metrics data 210 may be represented as a normalized or non-dimensional value. The standard metrics data 210 may also include a compliance rate, a single number, a percentage, and the like.

In some embodiments, the standard metrics data 210 or a portion thereof may be directed to a sub-function or particular domain in which one or more of the management services operate. For instance, the standard metrics data 210 may indicate an overall maturity and adoption of the management services (e.g., the automated ITSM service, workspace service, etc.) and may indicate the maturity and adoption of the management services in the domain. For instance, the domain may be human resources (HR). Accordingly, the standard metrics data 210 may indicate maturity and adoption of two or more management services (e.g., automated ITSM services, workspace services, etc.) relative to HR processes.

The metric generation module 150 may include a class module 234. The class module 234 may be configured to receive the standard metrics data 210 and generate the class metrics data 230. For instance, in some embodiments, the class module 234 may group the standard metrics data 210 according to two or more service classes. For instance, a first standard metrics data may indicate the maturity and the adoption of the product update management service in the managed network 110. For instance, the first standard metrics data may be 66% of the endpoints 106 are enrolled in automated patch deployment. A second standard metrics data may indicate the maturity and the adoption of the EASM service in the managed network 110. For instance, the second standard metrics data may be that the managed network 110 has not adopted the EASM service (e.g., 0%). The first and the second standard metrics may be grouped into a service class such as the preventative maintenance service class.

The class module 234 may combine the standard metrics with one or more other standard metrics of the same service class to generate a combined class metric for each of the service classes. For instance, in the above example, the two standard metrics data may be weighted and combined (e.g., 0.5*first standard metric+0.5*second standard metric). The combined class metric in this example may be 33%, which may indicate that about one-third of the preventative maintenance services are adopted and mature in the managed network 110. The class module 234 may generate the class metrics data 230. The class metrics data 230 may include combined class metrics for one or more or each of the service classes and/or graphical representation data of the combined class metrics. The class module 234 may cause display of the graphical representation data of the combined class metrics. For instance, the class module 234 may communicate the class metrics data 230 to the local management device 114. The metrics module 112 of the local management device 114 may cause display of the combined class metrics or the graphical representation data in a unified user interface. The standard metrics may be combined in other ways. For instance, in some embodiments, the standard metrics may be added, averaged, and the like.

In some embodiments, the standard metrics data 210 and/or the service classes may be characterized more generally as preventive services and curative services. The preventative services operate to pre-emptively mitigate issues in the managed network 110. The curative services operate responsive to a condition or an event experienced in the managed network 110. The service classes included in preventative services may include cyber-hygiene (also referred to as inoculation) and preventative maintenance. For instance, the management services included in the preventative service classes might include product update management service, workspace integration service, EASM service, preventative maintenance service (e.g., healing bot), environment management service, policy tools, application controls services, and the like. The management services included in the curative service classes might include self-healing service, user outreach service, ITSM (self-service and analyst-service), MDM service, workspace controls. Some management services may reflect some aspects of both preventative services and curative services such as digital user experience management, performance management service, and knowledge management service. The standard metric data 210 may be grouped according to service class and displayed together, which illustrates the overall management of the managed network 110 by the cloud management device 104.

In some embodiments, the implementation data 218 are received on an ongoing basis. For instance, the implementation data 218 may be received in real time or essentially real time (e.g., without material delay). In these and other embodiments, the standard metric data 210 and the class metrics data 230 are generated on an ongoing basis. In these and other embodiments, the standard metric data 210 and the class metrics data 230 may be time-dependent or time-stamped, which may enable historical analysis of the operation of the managed network 110.

The generation module 206 may also be configured to generate one or more potential parameters 214 (in FIG. 2B, “parameters 214”). The potential parameters 214 represent at least one instance in which at least one of the management services is applicable in the managed network 110 and not currently implemented. Additionally, the potential parameters 214 may include an unused management service that may be eliminated. For instance, an application control service may be implemented at a subset of the endpoints 106 that run a Windows™ operating system (OS), but not at the remaining endpoints 106. The generation module 206 may generate a potential parameter 214 that indicates that the application control service is not implemented at a second subset of the endpoints 106 that run an Apple™ OS or a Linux™ OS. The potential parameters 214 may be based on the portion of the received network information 220 and one or more parts of the implementation data 218.

In addition, in some embodiments, the generation module 206 may have access to additional information that relates to capabilities of the SAAS management engines 109. For instance, from the example above, the generation module 206 may have access to additional information indicating the ability of an application control service to interface with Apple and Linux OS. The potential parameter 214 may be based on this information.

The generation module 206 may further generate the recommendations 212. The recommendations 212 may be based on one or more of the potential parameters 214. For instance, one of the potential parameters 214 may include the failure to implement the application control service at the endpoints 106 running the Apple OS and Linux OS. The recommendation 212 may include a notification to an administrator that the endpoints 106 are not utilizing the application control service and/or instructions on how to enroll the endpoints 106. The recommendation 212 may be associated with one of the combined class metrics of the class metrics data 230. For instance, from the example above. The preventative maintenance class metric, which is the combination of the product update and EASM services, may be 33%. A recommendation to improve the class metric might be enabling the EASM service (which may raise the class metric from 33% to 83%).

The recommendation 212 may differ based on the management service it describes. For example, the management service may include a product update management service. The recommendation 212 related to the product update management service may include a change to patch coverage. The management service may include a knowledge management service. The recommendation 212 related to the knowledge management service may include ticket themes missing knowledge or AI-based ticket themes missing knowledge. The management service may include an automated ITSM service. The recommendation 212 related to the automated ITSM service may include changes to the service that improve resolution metrics. The management service may include a workspace integration service. The recommendation 212 related to the workspace integration service use of remote control, use of one-to-one edge intelligence, use of one-to-many edge intelligence, use of custom action bots, or available templates to deploy. The management service may include a performance management service. The recommendation 212 related to the performance management service may include deployment of templates and configurations applicable in the managed network. The management service may include an MDM service. The recommendation 212 related to the MDM service may include a recommended set of triggers and actions to deploy in the managed network. The management service may include a self-healing service. The recommendation 212 related to the self-healing service may include an upgraded service that covers manual or IT-handled system modifications, a deployable bot template, or a suggested self-healable ticket on a service desk. The management service may include an environment management service. The recommendation 212 related to the environment management service may include a user group policy via environment management for improved precision, optimization of login operations by the environment management service, or desktop composition recommendations. The management service may include external attack service EASM service. The recommendation 212 related to the EASM service may include use or inclusion of EASM in the managed network 110. The management service may include a self-healing service or a preventative maintenance service. The recommendation 212 related to the preventative maintenance service may include an upgraded service that covers manual or IT-handled system modifications, available templates consumed, issue deflection bots, endpoint coverage, or preventable tickets. The management service may include an application control service. The recommendation 212 related to the application control service may include recommended ways to improve coverage of application management, restriction of administrative usage, or a leverage trusted ownership checking. The management service may include a user outreach service. The recommendation 212 related to the user outreach service may include recommended campaigns to deploy in the managed network.

The recommendation 212 may also include policy recommendations. The policy recommendations may be based on the indirect metrics 217. The policy recommendations may include modifications to the policy or the initiative that may improve adoption and/or satisfaction. For instance, a particular aspect of a policy may cause dissatisfaction. The policy recommendation may include a modification to the particular aspect of the policy.

The metric generation module 150 may be further configured to generate standard historical parameters and/or industry standard parameters. The standard historical parameters represent an implementation of one or more of the management services at a particular time or during a particular period of time. In some embodiments, the standard historical parameters are compared with a current standardized metric included in the standard metrics data 210. The comparison may illustrate changes to maturity of one or more of the management services, changes to results over time, implementation rates, and the like. The industry standard parameters may include a comparison between one of the standardized metrics included in the standard metrics data 210 (i.e., directed to the managed network 110) and implementation of a corresponding management service throughout an industry.

To generate the standard historical parameters, the metric generation module 150 may receive historical data 228 from the network database 152. The historical data 228 may represent operation of a portion of the managed network 110 related to one or more of the management services during a particular period of time. The generation module 206 may generate the historical parameter based on the historical data 228. The standardization module 208 may standardize the historical parameter to generate a historical standard parameter. The historical standard parameter may be compared to the standard metric. The historical standard parameter or a comparison between the historical standard parameter and one of the standard metrics may be communicated to the local management device 114.

To generate the industry standard parameters, the metric generation module 150 may receive industry data 226 from the third-party system 116. The industry data 226 may represent industry metrics related to one or more of the management services. The generation module 206 may generate the industry standard parameters based on the industry data 226. The industry standard parameters may be compared to a standard metric directed to the management service and represented in the standard metric data 210. The industry standard parameters or a comparison between the industry standard parameters and one of the standard metrics may be communicated to the local management device 114.

Additionally, the process 200 includes enabling visualization of graphical representation data (in FIG. 2B, “graphical rep. data”) 231. The graphical representation data 231 might include data representative of the indirect metrics 217, the domain metrics 221, the class metrics data 230, the recommendations 212, the potential parameters 214, or some combination thereof.

Visual representations of the graphical representation data 231 may be displayed at the local management device 114. For instance, in some embodiments, the metric generation module 150 may communicate the graphical representation data 231 to the metric module 112. The metric module 112 and/or the metric generation module 150 may cause display of the graphical representation data 231. In these and other embodiments, display of the graphical data may be caused in the UX 123, which may include a unified user interface.

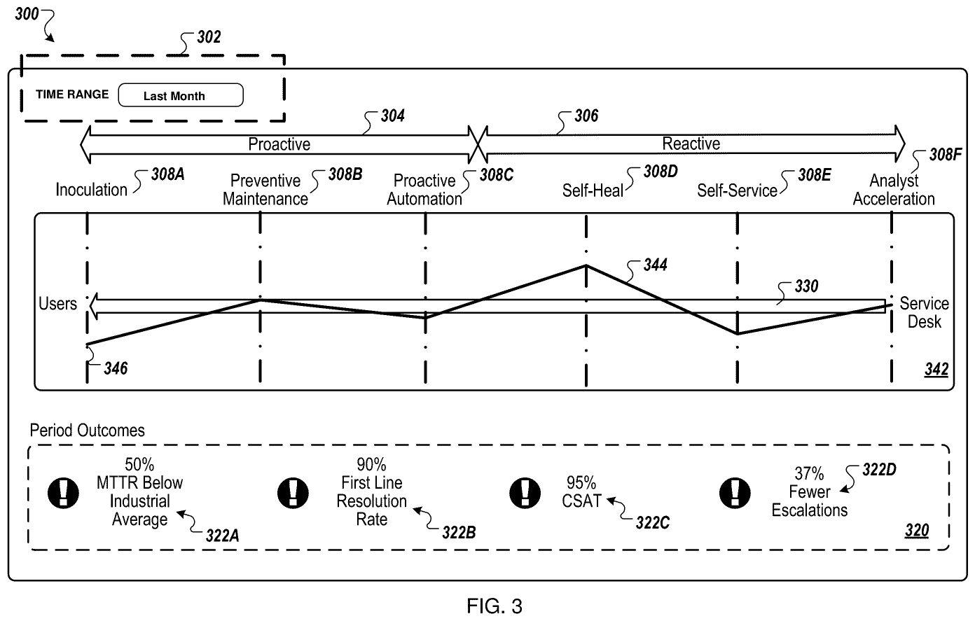

FIG. 3 is an example unified user interface (UX) 300 that may be implemented in the process 200 of FIGS. 2A and 2B. With combined reference to FIGS. 2 and 3, the unified UX 300 may be based on the class metrics data 230, the recommendation 212, the potential parameters 214, or some combination thereof. For instance, the class metrics data 230, the recommendation 212, the potential parameters 214 may be communicated to the metric module 112. Graphical representation data of the metric module 112 may be generated based on the class metrics data 230, the recommendation 212, the potential parameters 214. The graphical representation data may be communicated to the UX 123, where it is displayed as the unified UX 300.

Referring to FIG. 3, the unified UX 300 includes illustrative data. The unified UX 300 includes a time frame field 302, a graphical field 342, and a values field 320. The time frame field 302 enables input of a time frame within which data is displayed in the graphical field 342. The time frame may include a date range or may include a more generic time frame such as “last month.”

The graphical field 342 includes a class value line 344. The class value line 344 plots the combined class metrics data for each of the service classes 308A-308F (generally, service class 308 or service classes 308). In the depicted embodiment, the service classes 308 include an inoculation class 308A, a preventative maintenance class 308B, a proactive automation class 308C, a self-heal class 308D, a self-service class 308E, and an analyst acceleration class 308F. In other embodiments, other service classes may be included. The vertical axis in the graphical field 342 indicates combined maturity and adoption of services grouped into each of the classes. For instance, in the depicted representation, the maturity of the self-heal class 308D is higher (e.g., more mature and greater adoption) than the maturity of the inoculation class 308A.

Between the graphical field 342 and time frame field 302, the unified UX 300 may include a proactive indicator 304 and a reactive indicator 306. The proactive indicator 304 and the reactive indicator 306 illustrate to a view such as an administrator the characteristic of the service classes 308 displayed below them. For instance, the inoculation class 308A, the preventative maintenance class 308B, and the proactive automation class 308C may be characterized as “proactive” or preventative. The self-heal class 308D, the self-service class 308E, and the analyst acceleration class 308F may be characterized as “reactive.”

Additionally, the graphical field 342 may include a “shift left” indicator 330. The shift left indicator 330 generally illustrates sophistication level of an individual performing or involved in a management operation. For instance, to implement operations included in the analyst acceleration class 308F, a sophisticated individual is involved (i.e., an IT analyst). To implement operations included in the inoculation class 308A, there is little to no involvement of any personnel, which represents a “shift left” or shift from sophisticated and trained individuals to less sophisticated and automated operations.

In some embodiments, the class value line 344 enables display of recommendations. For instance, a point 346 at which the class value line 344 intersects a vertical, dashed line of the inoculation class 308A indicates the combine class metric for the inoculation class 308A. Selection of the point 346 may result in a display of a recommendation to change one or more of the management services to increase the combined class metric for the inoculation class 308A.

The values field 320 may include specific values related to the time period entered into the time frame field 302. In the depicted embodiment, a first value 322A includes comparison between the industry standard and one of the standard metrics. Specifically, the first value 322A indicates that the MTTR is 50% below the industrial average. A second value 322B and a third value 322C include standard metrics. Specifically, the second value 322B includes a first line resolution rate and the third value 322C includes a customer satisfaction rate. A fourth value 322D may include a historical comparison. For instance, the fourth value 322D indicates that over the time period entered into the time frame field 302, there was a reduction of 37% of escalation in an ITSM service.

FIG. 4 illustrates an example computer system 400 configured for managed network service assessment across multiple, diverse management services, according to at least one embodiment of the present disclosure. The computer system 400 may be implemented in the operating environment 100 FIG. 1, for instance. Examples of the computer system 400 may include the cloud management device 104, one or more of the endpoints 106, an edge device, or some combination thereof. The computer system 400 may include one or more processors 410, a memory 412, a communication unit 414, a user interface device 416, and a data storage 404 that includes one or more or a combination of the SAAS management engine 109, the DEXI engine 102, the ITSM engine 103, the UEM engine 111, the security engine 107, the MDM engine 108, the metric module 112, the metric generation module 150, the agent 121, and the products 115 (collectively, system modules 450).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 404, or the memory 412 and the data storage 404. In some embodiments, the processor 410 may fetch program instructions from the data storage 404 and load the program instructions in the memory 412. After the program instructions are loaded into the memory 412, the processor 410 may execute the program instructions.

The memory 412 and the data storage 404 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network (e.g., the network 120 of FIG. 1).

The user interface device 416 may include one or more pieces of hardware configured to receive input from and/or provide output to a user. In some embodiments, the user interface device 416 may include one or more of a speaker, a microphone, a display, a keyboard, a touch screen, or a holographic projection, among other hardware devices.

The system modules 450 may include program instructions stored in the data storage 404. The processor 410 may be configured to load the system modules 450 into the memory 412 and execute the system modules 450. Alternatively, the processor 410 may execute the system modules 450 line-by-line from the data storage 404 without loading them into the memory 412. When executing the system modules 450, the processor 410 may be configured to perform one or more processes or operations described elsewhere in this disclosure.

Modifications, additions, or omissions may be made to the computer system 400 without departing from the scope of the present disclosure. For example, in some embodiments, the computer system 400 may not include the user interface device 416. In some embodiments, the different components of the computer system 400 may be physically separate and may be communicatively coupled via any suitable mechanism. For example, the data storage 404 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules, as discussed in greater detail below.

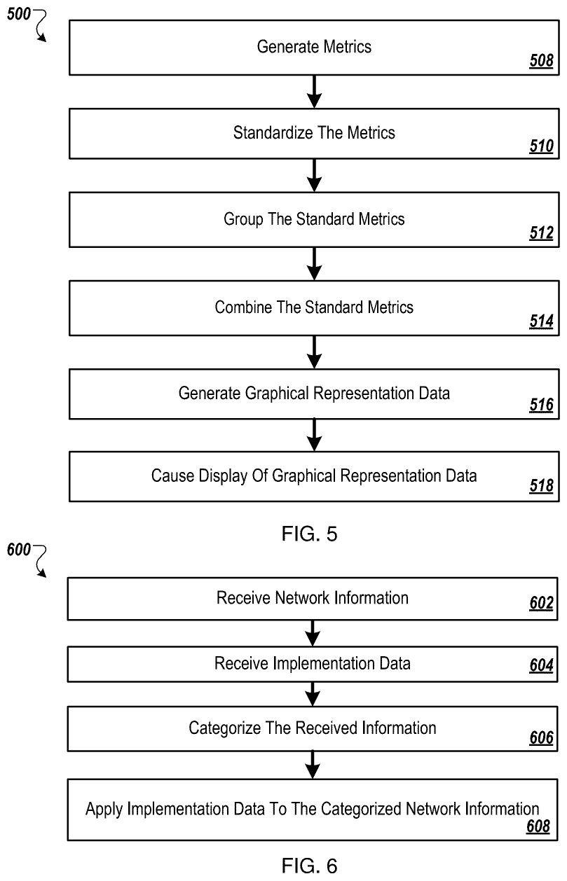

FIG. 5 is a flow chart of an example method 500 of managed network service assessment according to at least one embodiment. The method 500 may be implemented in an operating environment that includes a managed network in which in which multiple, different or diverse management services are provided. The multiple diverse management services might be unrelated or at least partially unrelated to one another and might apply to different aspects of the managed network.

At block 508, metrics may be generated. The metrics may be related to the management services, a particular domain, a policy implemented in the managed network, or some combination thereof. The metrics may be generated based on implementation data and network information. The implementation data is generated during operation of the management services in the managed network. The network information includes data and parameters related to endpoints, products, network configuration, policies, initiatives, etc. of the managed network. The metrics may be based on parts of the implementation data and portions of the network information. For instance, a first metric may be based on a first part of the implementation data and a first portion of the received network information. The first metric may be configured to represent operation of the first management service in the managed network.

Multiple metrics and multiple types of metrics may be generated. For instance, in some embodiments three types of metrics may be generated. The types of metrics may include service metrics, domain metrics, and indirect metrics. The service metrics may represent implementation of one or more of the management services in the managed network. The domain metrics may represent implementation of one or more of the management services limited or focused on a particular domain. For instance, a first domain metric may represent one or more management services implemented in human resources processes. The indirect metrics may represent implementation of a policy or initiate in the managed network. Other metrics and metric types may be implemented in some embodiments.

At block 510, the metrics may be standardized. The metrics may be standardized relative to the managed network to generate standard metrics. The standard metrics indicate maturity and adoption of the management services or the policy in the managed network. The standard metrics may be abstracted or normalized values, which may enable combinations and comparisons between the standard metrics.

At block 512, the standard metrics may be grouped. The standard metrics may be grouped according to two or more service classes. The service classes may be illustrative of timing and administrative involvement of the management services. For example, a first service class may include a first subset of the standard metrics that represent one or more of the management services that are preemptive, and a second service class may include a second subset of the standard metrics that represent one or more of the management services that are self-help. At block 514, the standard metrics may be combined. The standard metrics may be combined with one or more other standard metrics of the same service class. The standard metrics may be combined to generate a combined class metric for each of the service classes.

At block 516, graphical representation data may be generated. The graphical representation data may be generated for the combined class metrics, the standard metrics, the service metrics, or some combination thereof. At block 518, display of the graphical representation data may be caused. For instance, the graphical representation data may include a first combined class metric (e.g., a preemptive class metric) and a second combined class metric (e.g., a self-service class metric), which may be caused to be displayed. In some embodiments, the graphical representation data may be caused to be displayed in a unified UX.

FIG. 6 is a flow chart of an example method 600 of metric generation according to at least one embodiment. The method 600 may be implemented in an operating environment that includes a managed network in which in which multiple, different or diverse management services are provided. The method 600 may be implemented as part of another method such as block 508 of the method 500.

The method 600 may begin at block 602 in which network information may be received. The network information is associated with the managed network. The information may include identification of at least a portion of endpoints of the managed network, product status at the endpoints, use behavior at the endpoints, incident resolution data, admin input, parameters of policies implemented in the managed network, other information related to the managed network, or combinations thereof. The network information may be accessed in some embodiments from agents at the endpoints. The network information may also be communicated from an administrative entity or administrative endpoint.

At block 604, implementation data may be received. The implementation data represents execution of a management services of the multiple, diverse management services in the managed network. The implementation data may be received from management service engines that implement the management services. The management services are different. Accordingly, the first part of the implementation data and a second part of the implementation data may be different. Indeed in some embodiments, the first and second parts of the implementation data may include entirely different data.

The management services may include any service that administers, controls, establishes, or restricts operation of the managed network or at least a portion of the endpoints included in the managed network. Some examples of a first management service and a second management service include a product update management service, an environment management service, an application control service, an external attack service management service, a preventative maintenance service, a self-healing service, a mobile device management service, a performance management service, a workspace integration service, a user outreach service, an automated information technology (IT) service management service, another management service, or a combination thereof.

At block 606, the received network information may be categorized. The network information is categorized such that it is associated with a related management service, policy, or domain. For example, the received network information may be categorized such that a first portion of the received network information is associated with a first management service and a second portion of the received network information is associated with a second management service. The categorizing the received information is based on a features of the management service. For instance, the features might include which endpoints are affected, which services are rendered, frequency of the services, and the like. Additionally, the network information may be categorized to relate to a policy that is implemented in the managed network and/or categorized according to a particular domain. For instance, some of the network information might relate to a policy implemented in the managed network. For instance, the network information may identify endpoints to which the policy is applied, a timeframe surrounding the policy, a measure of successful implementation of the policy, and the like. Similarly, the network information may identify processes in a domain that are supported by the management services such as HR employee management, HR benefit selection, password management, and the like.

At block 608, one or more parts of the implementation data may be applied to the categorized network information. Application of the implementation data to the categorized network information generates a metric that quantifies one or more aspects of the managed network. For instance, the implementation data might indicate that fifteen surveys were distributed to ten endpoints. The network information might indicate that the managed network includes the identification information of the endpoints. The metric might quantify an average number of times the endpoints are surveyed. Metrics vary widely. Some examples of the metrics are provided elsewhere in the present disclosure.

In some embodiments, the implementation data are received on an ongoing basis. For instance, the first and the second implementation data may be received in real time or essentially real time (e.g., without material delay). In these and other embodiments, the metrics may be generated on an ongoing basis and may be time dependent.

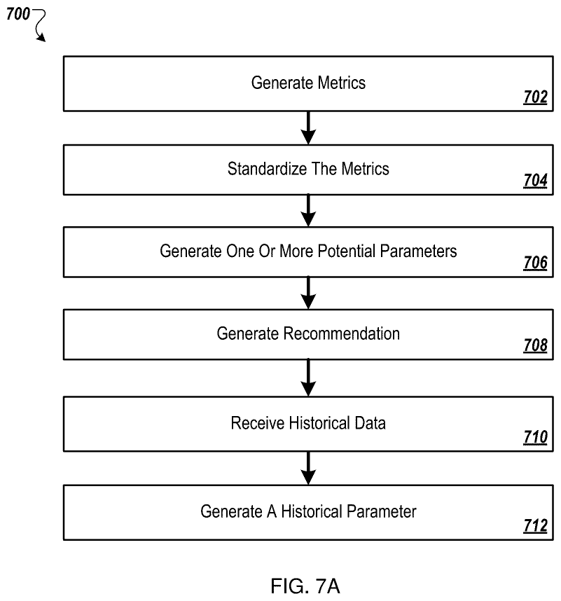

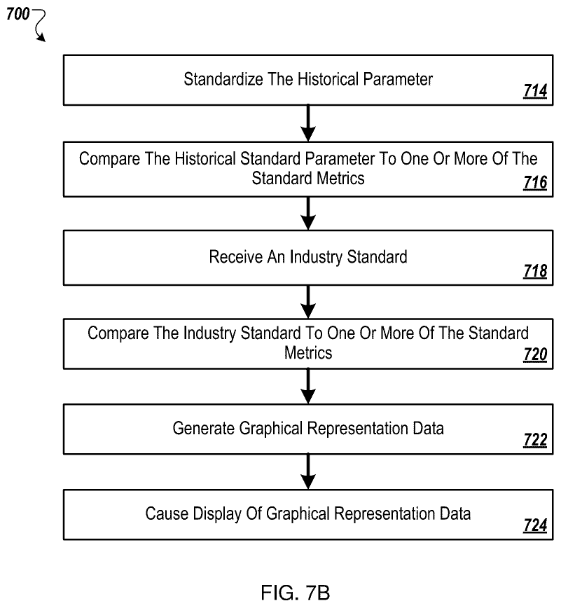

FIGS. 7A and 7B are a flow chart of an example method 700 of metric quantification supplementation according to at least one embodiment. The method 700 may be implemented in an operating environment that includes a managed network in which in which multiple, different or diverse management services are provided. The method 700 may be implemented with at least portions of the method 500 as described in the following paragraphs. The method 700 may be implemented to supplement a metrics quantification process such as that described in the method 500 or a portion thereof.

Referring to FIG. 7A, the method 700 may begin at block 702 in which metrics are generated. Operations of block 702 may be substantially similar to the operations of block 508 of method 500. Additionally, in some embodiments, generation of metrics may be performed as described in the method 600. At block 704, the metrics may be standardized to generate standard metrics. Operations of block 704 may be substantially similar to the operations of block 510 of the method 500.

At block 706, one or more potential parameters may be generated. The one or more potential parameters represent an instance in which at least one of the management services is applicable or potentially applicable in the managed network and not currently implemented. The one or more potential parameters may be based on received information, the implementation data, and the standard metrics. Thresholds may be tied to the standard metrics that initiate or prompt generation of the potential parameters. In addition, the potential parameters may be based on a comparison of the management services implemented in the managed network and additional management services or additional management operations, which may identify missing or potentially beneficial management services.

At block 708, a recommendation may be generated based on the one or more potential parameters. The recommendation may provide a step or an action that modifies the management services to address or mitigate a shortcoming of currently implemented management services or a currently implemented policy. The recommendations may include an addition of an additional management service (e.g., adding a DEX service), an addition of a feature of a currently implemented service (e.g., adding Apple patching to a product update service), a modification of a currently implemented endpoint configuration (e.g., removing a product or modifying a problematic firewall setting), and the like.

In some embodiments, the method 700 may include generating standard historical parameters and/or industry standard parameters. In these and other embodiments, the method 700 may include blocks 710, 712, 714, 716, 718, 720, or some combinations thereof. In embodiments in which standard historical parameters are not generated, blocks 710, 712, 714, and 716 may be omitted. In embodiments in which industry standard parameters are not generated, blocks 718 and 720 may be omitted. At block 710, historical data may be received. The received historical data may represent operation of a portion of the managed network related to one or more of the management services during a particular period of time. At block 712, a historical parameter may be generated based on the historical data.

Referring to FIG. 7B, at block 714, the historical parameter may be standardized to generate a historical standard parameter. At block 716, the historical standard parameter may be compared to the first standard metric. At block 718, an industry standard related to the first management service may be received. At block 720, the industry standard may be compared to the first standard metric. At block 722, graphical representation data may be generated. The graphical representation data may include the recommendations, comparisons between the historical standard parameters and one or more of the standard metrics, and comparisons between the industry standards and the one or more standard metrics. At block 724, display of the graphical representation data may be caused. For instance, the graphical representation data may include one or more recommendations and the comparisons, which may be caused to be displayed. In some embodiments, the graphical representation data may be caused to be displayed in a unified UX.

Further, modifications, additions, or omissions may be made to the methods 500, 600, and 700 without departing from the scope of the present disclosure. For example, the operations of methods 500, 600, and 700 may be implemented in differing orders. Furthermore, the outlined operations and actions are only provided as examples, and some of the operations and actions may be optional, combined into fewer operations and actions, or expanded into additional operations and actions without detracting from the disclosed embodiments.

The methods 500, 600, and 700 may be performed by the cloud management device 104 described elsewhere in the present disclosure or by another suitable computing system, such as the computer system 400 of FIG. 4. In some embodiments, the cloud management device 104 or the other computing system may include or may be communicatively coupled to a non-transitory computer-readable medium (e.g., the memory 412 of FIG. 4) having stored thereon programming code or instructions that are executable by one or more processors (such as the processor 410 of FIG. 4) to cause a computing system or the cloud management device 104 to perform or control performance of the methods 500, 600, and 700. Additionally or alternatively, the cloud management device 104 may include the processor 410 that is configured to execute computer instructions to cause the cloud management device 104 or other computing systems to perform or control performance of the methods 500, 600, and 700. The cloud management device 104 or the computer system 400 implementing the methods 500, 600, and 700 may be included in a cloud-based managed network, an on-premises system, or another suitable network computing environment. Although illustrated as discrete blocks, one or more blocks in FIGS. 5-7B may be divided into additional blocks, combined into fewer blocks, or eliminated, depending on the desired implementation.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of managed network service assessment across a plurality of diverse management services implemented in the managed network, the method comprising:
receiving network information associated with a managed network, the network information including identification of at least a portion of endpoints of the managed network, product status at the endpoints, use behaviour at the endpoints, and incident resolution data;
receiving implementation data that represents execution of management services of the plurality of diverse management services in the managed network;
categorizing the received information into portions that are associated with one or more of the management services;
generating service metrics related to the management services based on the implementation data and one or more portions of the received information, wherein the service metrics are configured to represent operation of each of the management services in the managed network;
standardizing the service metrics to generate standard metrics, wherein the standard metrics indicate maturity and adoption of each of the management services in the managed network in an abstracted form;
grouping the standard metrics according to two or more service classes, wherein the service classes are illustrative of timing and administrative involvement of the management services;
combining the standard metrics with one or more other standard metrics of the same service class to generate a combined class metric for each of the service classes;
generating graphical representation data of the combined class metrics; and
causing display of the combined class metrics in a unified user interface.

2. The method of claim 1, wherein a first subset of the service classes are preventative service classes in which the management services operate to pre-emptively mitigate issues in the managed network and a second subset of the service classes are curative service classes in which the management services operate responsive to a condition or an event experienced in the managed network.

3. The method of claim 1, wherein:
the received network information includes information related to a policy implemented in the managed network;
the received information is further categorized into one or more additional portions that are associated with the policy; and
the method further comprises generating an indirect metric related to the policy, wherein the indirect metric is indicative of maturity and adoption of the policy in the managed network, and the indirect metric is based on the additional portions of the received information and a part of the implementation data or derivatives of the part of the implementation data.

4. The method of claim 3, further comprising:
generating additional graphical representation data of the indirect metric;
causing display of the additional graphical representation data of the indirect metric in the unified user interface, wherein the indirect metric further indicates satisfaction of the policy as implemented in the managed network, and the policy includes a remote work policy, a facility's management policy, or a human resources process;
generating a policy recommendation based on the indirect metric; and
causing display of the recommendation in the unified user interface.

5. The method of claim 1, wherein the management services include:
a product update management service;
an environment management service;
an application control service;
an external attack service management service;
a preventative maintenance service;
a self-healing service;
a mobile device management service,
a performance management service;
a workspace integration service;
a user outreach service; or
an automated information technology (IT) service management service.

6. The method of claim 1, further comprising:
receiving historical data that represents operation of a first management service of the management services in the managed network during a particular period of time;
generating a historical parameter based on the historical data;
standardizing the historical parameter to generate a historical standard parameter; and
comparing the historical standard parameter to a first standard metric of the standard metrics, wherein the first standard metric is an abstracted form of a first service metric corresponding to the first management service.

7. The method of claim 1, further comprising:
receiving an industry standard related to a first management service of the management services;
comparing the industry standard to a first standard metric of the standard metrics, wherein the first standard metric is an abstracted form of a first service metric corresponding to the first management service in the managed network; and
causing display of a comparison between the industry standard and the first standard metric.

8. The method of claim 1, further comprising:
generating a potential parameter that represents at least one instance in which one of the management services is applicable in the managed network and not currently implemented, wherein the potential parameter is based on a portion of the received network information and at least a part of the implementation data.
generating a recommendation based on the potential parameter; and
causing display of the recommendation in the unified user interface,
wherein:
a first management service of the management services includes a product update management service;
a first service metric includes a number of the endpoints patched according to policy compared to a number of discovered endpoints, an implemented patching cadence, a time to patch across the managed network, a patch compliance rate, a patch installation success rate, a number of failed patch remediations, or an analysis of received patch feedback; and
the recommendation includes a change to patch coverage.

9. The method of claim 1, wherein:
the implementation data are received on an ongoing basis;
the service metrics are generated on an ongoing basis; and
the combined class metrics are time dependent.

10. The method of claim 1, wherein:
the received information is further categorized into one or more additional portions that are associated with a particular domain of the managed network; and
the method further comprises generating a domain metric related to the particular domain, wherein the domain metric is indicative of maturity and adoption of one or more of the management services in the particular domain.

11. A non-transitory computer-readable medium having encoded therein programming code executable by one or more processors to perform or control performance of operations of managed network service assessment across a plurality of diverse management services implemented in the managed network, the operations comprising:
receiving network information associated with a managed network, the network information including identification of at least a portion of endpoints of the managed network, product status at the endpoints, use behaviour at the endpoints, and incident resolution data;
receiving implementation data that represents execution of management services of the plurality of diverse management services in the managed network;
categorizing the received information into portions that are associated with one or more of the management services;
generating service metrics related to the management services based on the implementation data and one or more portions of the received information, wherein the service metrics are configured to represent operation of each of the management services in the managed network;
standardizing the service metrics to generate standard metrics, wherein the standard metrics indicate maturity and adoption of each of the management services in the managed network in an abstracted form;
grouping the standard metrics according to two or more service classes, wherein the service classes are illustrative of timing and administrative involvement of the management services;
combining the standard metrics with one or more other standard metrics of the same service class to generate a combined class metric for each of the service classes;
generating graphical representation data of the combined class metrics; and
causing display of the combined class metrics in a unified user interface.

12. The non-transitory computer-readable medium of claim 11, wherein a first subset of the service classes are preventative service classes in which the management services operate to pre-emptively mitigate issues in the managed network and a second subset of the service classes are curative service classes in which the management services operate responsive to a condition or an event experienced in the managed network.

13. The non-transitory computer-readable medium of claim 11, wherein:
the received network information includes information related to a policy implemented in the managed network;
the received information is further categorized into one or more additional portions that are associated with the policy; and
the operations further comprise generating an indirect metric related to the policy, wherein the indirect metric is indicative of maturity and adoption of the policy in the managed network, and the indirect metric is based on the additional portions of the received information and a part of the implementation data or derivatives of the part of the implementation data.

14. The non-transitory computer-readable medium of claim 13, wherein the operations further comprise:
generating additional graphical representation data of the indirect metric;
causing display of the additional graphical representation data of the indirect metric in the unified user interface, wherein the indirect metric further indicates satisfaction of the policy as implemented in the managed network, and the policy includes a remote work policy, a facility's management policy, or a human resources process;
generating a policy recommendation based on the indirect metric; and
causing display of the recommendation in the unified user interface.

15. The non-transitory computer-readable medium of claim 11, wherein the management services include:
a product update management service;
an environment management service;
an application control service;
an external attack service management service;
a preventative maintenance service;
a self-healing service;
a mobile device management service,
a performance management service;
a workspace integration service;
a user outreach service; or
an automated information technology (IT) service management service.

16. The non-transitory computer-readable medium of claim 11, wherein the operations further comprise:
receiving historical data that represents operation of a first management service of the management services in the managed network during a particular period of time;
generating a historical parameter based on the historical data;
standardizing the historical parameter to generate a historical standard parameter; and
comparing the historical standard parameter to a first standard metric of the standard metrics, wherein the first standard metric is an abstracted form of a first service metric corresponding to the first management service.

17. The non-transitory computer-readable medium of claim 11, wherein the operations further comprise:
receiving an industry standard related to a first management service of the management services;
comparing the industry standard to a first standard metric of the standard metrics, wherein the first standard metric is an abstracted form of a first service metric corresponding to the first management service in the managed network; and
causing display of a comparison between the industry standard and the first standard metric.

18. The non-transitory computer-readable medium of claim 11, wherein:
the operations further comprise:
generating a potential parameter that represents at least one instance in which one of the management services is applicable in the managed network and not currently implemented, wherein the potential parameter is based on a portion of the received network information and at least a part of the implementation data.
generating a recommendation based on the potential parameter; and
causing display of the recommendation in the unified user interface,
a first management service of the management services includes a product update management service;
a first service metric includes a number of the endpoints patched according to policy compared to a number of discovered endpoints, an implemented patching cadence, a time to patch across the managed network, a patch compliance rate, a patch installation success rate, a number of failed patch remediations, or an analysis of received patch feedback; and
the recommendation includes a change to patch coverage.

19. The non-transitory computer-readable medium of claim 11, wherein:
the implementation data are received on an ongoing basis;
the service metrics are generated on an ongoing basis; and
the combined class metrics are time dependent.

20. The non-transitory computer-readable medium of claim 11, wherein:
the received information is further categorized into one or more additional portions that are associated with a particular domain of the managed network;
the operations further comprise generating a domain metric related to the particular domain; and
the domain metric is indicative of maturity and adoption of one or more of the management services in the particular domain.
